(19) United States
(12) Patent Application Publication
(10) Pub. No.: US 2004/0181673 A1
(43) Pub. Date: Sep. 16, 2004

(54) Method and apparatus for preventing unauthorized access to data and for destroying data upon receiving an unauthorized data access attempt

(76) Inventors: Paul Lin, Fremont, CA (US); Harry Lee, Foster City, CA (US); Henry Hon, Berkeley, CA (US)

Correspondence Address: Jeffrey P. Aiello, 4911 Pony Pass Circle, San Jose, CA, 95136, US

(21) Appl. No.: 10/387,883

(22) Filed: Mar. 13, 2003

(51) Int. Cl. H04K 1/00

(52) U.S. Cl. 713/182

(57) ABSTRACT

A method and apparatus for preventing unauthorized access to data and for destroying selected data upon receiving a “false” access code during a final access attempt is provided. A counter is utilized to count a selected number of data access attempts. If a “true”, or correct, access code is entered before the final access attempt is reached, the counter is reset and access to the selected data is granted. If the “true” access code is not entered on the final access attempt, then a data-destruct mechanism is invoked to destroy the selected data. The selected data may reside on a token device, a personal computer, computer server, or combinations thereof.

### BACKGROUND OF THE INVENTION

1. Field of the Invention

The present invention relates generally to methods and apparatus for preventing unauthorized access to data and, more particularly, to a method and apparatus for preventing unauthorized access to data and for destroying selected data upon receiving an unauthorized data access attempt.

2. Background Information

Preventing unauthorized access to confidential data is of paramount concern in today's computer and computer network environments. Confidential information is commonly stored on personal computers, network server computers, and often transferred over computer networks. Much of this confidential information may be highly valuable to unauthorized parities as it may represent a user's financial or personal information.

Passwords, Personal Identification Numbers (PINs), data encryption, and encrypted shared secrets are known mechanisms for preventing unauthorized access to data. Access codes, such as passwords and PINs make unauthorized access to protected data extremely difficult.

However, as the technology for preventing unauthorized access to data advances, equal advances are made in the methods for gaining unauthorized access to confidential data to decode or “hack” user access codes, which may be passwords or PINs. For example, a party, commonly known as a “hacker”, logs on to a computer server that contains confidential data. The hacker may generate or invoke a computer program that may generate code representing false access codes for gaining access the confidential data stored on the computer server. Each false access code generated by the hacker is submitted to the computer server until a false access code is accepted by the computer sever, indicating that the false access code is accepted as an authorized access code. The hacker then has achieved unauthorized access to the computer server.

A known method for preventing unauthorized access to confidential data, such as by the method discussed above, is to limit the number of access attempts. Each access attempt is counted by a counter. Upon inputting a correct access code, the counter is reset and access to the data is granted.

If the correct access code is not input prior to the counter reaching a selected number of access attempts, further access attempts are denied. The user, or hacker, may be automatically logged of the computer server for a period of time, thus inhibiting access to the data. However, the hacker can easily re-log on to the computer server and resume generating and submitting access codes until they either generate a correct access code or are again denied further access attempts. The hacker can repeat this process until a correct access code is eventually obtained.

### BRIEF SUMMARY OF THE INVENTION

The present invention provides a method and apparatus for preventing unauthorized access to selected data and for destroying the selected data upon receiving a “false” access code during a final access attempt. A counter is utilized to count a selected number of data access attempts. If a “true”, or correct, access code is entered before the final access attempt is reached, the counter is reset and access to the selected data is granted.

If the “true” access code is not entered on the final access attempt, then a data-destruct mechanism is invoked to destroy the selected data. The selected data may reside on a token device, a personal computer, computer server, or combinations thereof.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a schematic diagram of a computer coupled to a computer network and a token device of the present invention; and

FIG. 2 is a flow chart showing a preferred embodiment of the method of the present invention.

### DESCRIPTION OF THE PREFERRED EMBODIMENTS

The following description is provided to enable any person skilled in the art to make and use the invention and sets forth the best modes presently contemplated by the inventors of carrying out the invention. Various modifications, however, will remain readily apparent to those skilled in the art, since the generic principles of the present invention have been defined herein.

The present invention provides a method and apparatus for preventing unauthorized access to selected data and for destroying the selected data upon receiving a “false” access code during a final access attempt. A counter is utilized to count a selected number of data access attempts. If a “true”, or correct, access code is entered before the final access attempt is reached, the counter is reset and access to the selected data is granted.

If the “true” access code is not entered on the final access attempt, then a data-destruct mechanism is invoked to destroy the selected data. The selected data may reside on a token device, a personal computer, computer server, or combinations thereof.

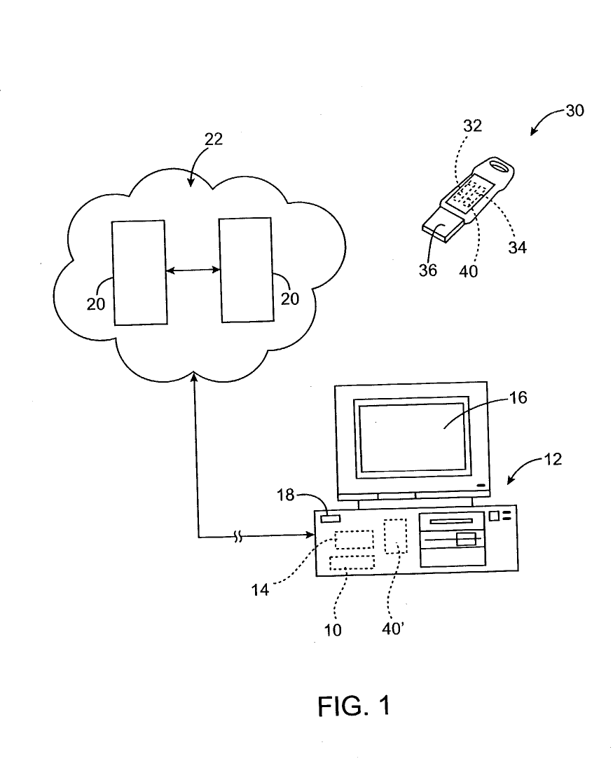

Referring now to FIG. 1 of the drawings, a preferred embodiment of the method of the present invention may be uploaded to a data storage device 10 of a computer 12, using known means. For example, the invented method may be provided in the form of a computer program and uploaded onto the computer 12 and stored on the storage device 10, as is well known.

Similarly, the method of the present invention may be installed on one or more servers 20 of a computer network, shown generally at 22. The computer network 22 may comprise a multiplicity of servers 20, several of which may be interconnected at any given time. The computer network 22 may comprise the Internet or a company's intranet.

As referred to hereinafter, the term “computer” references any device capable of processing data, and optionally, coupling to the computer network 22. The computer 12 may comprise any remote computing terminal which can provide a client access to the computer network 22, such as a well known ATM machine, for example. The computer 12 may be provided with a processor 14 for processing data and a memory. The computer 12 may also include a display device 16 for displaying information to a user. The computer 12 may include a data port 18 to allow coupling of external devices to the network 22, via the computer 12.

The computer 12 may be coupled to the network 22 via any known means. The computer 12 may be continuously coupled to the network 22, via a high bandwidth digital communications line, or may be intermittently coupled to the network 22, via a modem, for example.

A unique token device, or token, 30 is configured to couple to the data port 18. The token 30 and data port 18 may be configured in any desired mutually compatible form factor which affords coupling and decoupling of the token 30 with the data port 18, and thus to the network 22 via the computer 12. For example, the data port 18 may comprise a known USB (Universal Serial Bus) port or similar data port.

The token 30 may include an on-board processor 32 for processing data, a memory device 34 for storing data, and a coupling portion 36 for coupling the token 30 to the data port 18. The on-board processor 32 may be capable of processing 128-bit data.

The token's memory device, or memory, 34 may comprise a nonvolatile memory device that is configured to maintain data when power to the token 30 is removed. Preferably, the memory device 34 comprises a known flash memory device.

The present invention also includes a counter 40. The counter 40 may be located at any suitable location where access attempts to selected data may be counted by the counter. The counter 40 may be located on a computer 12, a server 20 of the network 22, or in the token 30. The counter 40 is programmed to select a maximum number of access attempts.

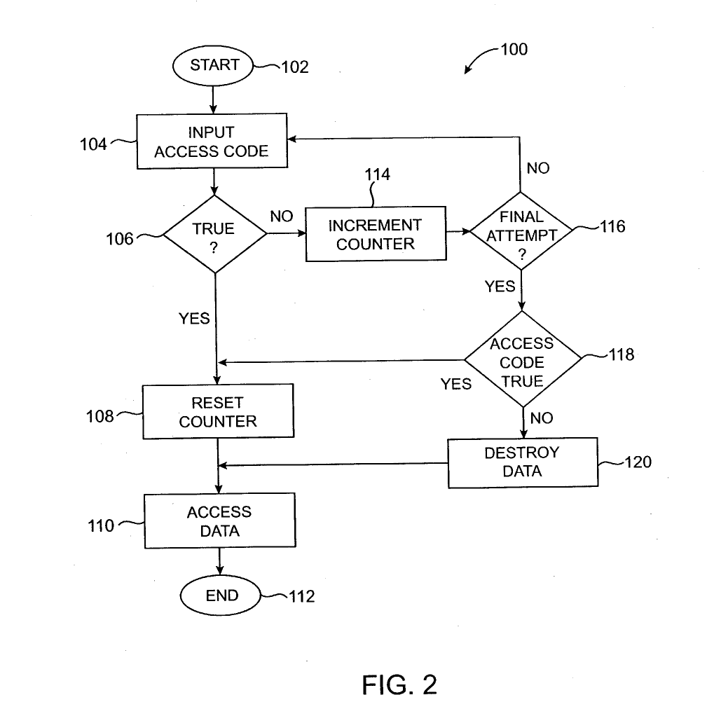

Referring now to FIG. 2 of the drawings, there is shown generally at 100, a first preferred method of the invention. A user desires to access data secured by the invention, via the computer 12. The user invokes the invented method 100, shown in start block 102, to access selected data. As shown in process block 104, the method requests the user for an access code. The access code may be a numeric or alphanumeric password or PIN, as is known. The user may then input the access code using known means. The method 100 may also display to the user, via the display device 16, the maximum number of access attempts allowed.

As shown in decision block 106, if the user's access code registers “true”, the user is granted access to the selected data. In process block 108, the counter 40 is reset, then the method continues to process block 110, where the user is allowed access to the data. The method 100 ends in end block 112.

Returning to decision block 106, if the user's access code registers “false”, the method proceeds to process block 114, where the failed access attempt increments the counter 40. The counter 40 is incremented by one for each failed access attempt until a final access attempt is reached. Alternatively, the counter 40 may be initialized with a given value, then may be decremented for each failed access attempt until “0” is reached.

In decision block 116 it is determined if the final access attempt is reached. If it is not the final access attempt, then the method 100 returns to process block 104 to allow the user to again input the access code.

If the final access attempted is reached, in decision block 116, the method may optionally notify the user that they are at the final access attempt. Further, the user may be notified that submitting a “false” access code on the final access attempt will result in the destruction of the selected data that they are attempting to access.

On the final access attempt the user may again input their access code. The method 100 continues to decision block 118, where it is determined if the access code is “true”. If the access code is true, the method continues to process block 108, where the counter 40 is reset. The method 100 then continues to process block 110, where the user is allowed access to the data.

If it is determined in decision block 118 that a “false” access code is entered, then the method continues to process block 120. In process block 120 the method 100 invokes a data-destruct mechanism for destroying selected data that the user may be attempting to access. The data-destruct mechanism may comprise any suitable data-destruct mechanism, such as a known method, device, or combination thereof, known in the art that is capable of destroying the data. The data may reside on the computer 12, computer server 20, token 30, or combinations thereof.

Referring now to FIG. 1 and FIG. 2 of the drawings, the selected data may be encrypted and may be stored on a computer 12 or server 20. Means for accessing the encrypted selected data, such as an encryption/decryption key, may comprise a shared secret. A portion of the shared secret may reside on the token 30 and a corresponding portion on the shared secret may reside on the computer 12 or computer server 20.

In order to access the information stored on the token 30, the user must first input an access code, such as a password or PIN, as discussed above. The user couples their unique token device 30 to the computer 12. The user invokes the method 100, shown in FIG. 2, to access the information stored on the token 30. Upon entering the “true” access code, the user may access the encrypted data using various means.

If the user enters a “false” access code on the final access attempt, the data stored on the token 30 will be destroyed. Further, selected data, such as data stored on the computer 12 and computer server 20, may optionally be destroyed.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for preventing unauthorized access to selected data and for destroying the selected data, the method comprising the following steps:
(a) inputting an access code;
(b) determining if the access code is true or false;
(c) if the access code is true, then granting access to selected data; and
(d) if the access code is false, determining if a final access attempt is reached, if the final access attempt is reached, then performing the following steps,
(i) determining if the access code input on the final access attempt is true;
(ii) if the access code is true, then granting access to selected data; and
(iii) if the access code is false, then invoking a data destruct mechanism to destroy the selected data.

2. The method of claim 1 wherein the selected data is stored on a storage device of a computer.

3. The method of claim 1 wherein the selected data is stored on a storage device of a computer server.

4. A method for preventing unauthorized access to selected data and for destroying the selected data, the method comprising the following steps:
(a) inputting an access code;
(b) determining if the access code is true or false;
(c) if the access code is true, then granting access to selected data; and
(d) if the access code is false, then incrementing a counter and returning to step (a) until a final access attempt is reached, if the final access attempt is reached, then performing the following steps,
(i) determining if the access code input on the final access attempt is true;
(ii) if the access code is true, then granting access to selected data; and
(iii) if the access code is false, then invoking a data destruct mechanism to destroy the selected data.

5. A method for preventing unauthorized access to selected data and for destroying the selected data, the method comprising the following steps:
(a) coupling a token device to a computer;
(b) inputting an access code;
(c) determining if the access code is true or false;
(d) if the access code is true, then granting access to selected data; and
(e) if the access code is false, then incrementing a counter and returning to step (a) until a final access attempt is reached, if the final access attempt is reached, then performing the following steps,
(i) determining if the access code input on the final access attempt is true;
(ii) if the access code is true, then granting access to selected data; and
(iii) if the access code is false, then invoking a data destruct mechanism to destroy the selected data.

6. The method of claim 5 wherein the selected data is stored on the token device.

7. The method of claim 5 wherein the selected data is stored on a storage device of a computer.

8. The method of claim 5 wherein the selected data is stored on a storage device of a computer server.

9. A method for limiting access attempts to data and for destroying the data upon receipt of final failed access attempt, the method comprising the following steps:
(a) inputting an access code;
(b) determining if the access code is true or false;
(c) if the access code is true, then granting access to selected data; and
(d) if the access code is false, then incrementing a counter and returning to step (a) until a final access attempt is reached, if the final access attempt is reached, then performing the following steps,
(i) determining if the access code input on the final access attempt is true;
(ii) if the access code is true, then granting access to selected data; and
(iii) if the access code is false, then invoking a data destruct mechanism to destroy the selected data.

10. A method for limiting access attempts to data and for destroying the data upon receipt of final failed access attempt, the method comprising the following steps:
(a) coupling a token device to a computer;
(b) inputting an access code;
(c) determining if the access code is true or false;
(d) if the access code is true, then granting access to selected data; and
(e) if the access code is false, then incrementing a counter and returning to step (a) until a final access attempt is reached, if the final access attempt is reached, then performing the following steps,
(i) determining if the access code input on the final access attempt is true;
(ii) if the access code is true, then granting access to selected data; and
(iii) if the access code is false, then invoking a data destruct mechanism to destroy the selected data.
